(19) United States
(12) Patent Application Publication
(10) Pub. No.: US 2014/0346376 A1
(43) Pub. Date: Nov. 27, 2014

(54) LASER APPARATUS AND EXTREME ULTRAVIOLET LIGHT GENERATION APPARATUS

(71) Applicant: GIGAPHOTON INC., Oyama-shi (JP)

(72) Inventors: Krzysztof NOWAK, Oyama-shi (JP); Osamu WAKABAYASHI, Oyama-shi (JP)

(21) Appl. No.: 14/455,743

(22) Filed: Aug. 8, 2014

Related U.S. Application Data
(63) Continuation of application No. PCT/IB2013/000184, filed on Feb. 13, 2013.

(30) Foreign Application Priority Data
Mar. 30, 2012 (JP) 2012-078928
Dec. 4, 2012 (JP) 2012-265660

(51) Int. Cl. H01S 3/00; G02F 1/03; H05G 2/00; H01S 3/11

(52) U.S. Cl. CPC H01S 3/0064; H01S 3/11; G02F 1/0322; G02F 1/0316; H05G 2/008
USPC 250/504 R; 359/245; 359/257

(57) ABSTRACT

A laser apparatus may include a master oscillator configured to output a pulse laser beam, at least one amplifier provided in a path of the pulse laser beam from the master oscillator, and at least one first optical isolator provided in the path of the pulse laser beam, the first optical isolator including at least one of a GaAs crystal and a CdTe crystal as an electro-optic crystal.

### CROSS-REFERENCE TO RELATED APPLICATIONS

The present application claims priority from Japanese Patent Application No. 2012-078928 filed Mar. 30, 2012 and Japanese Patent Application No. 2012-265660 filed Dec. 4, 2012.

### BACKGROUND

1. Technical Field

The present disclosure relates to a laser apparatus and a system for generating extreme ultraviolet (EUV) light.

2. Related Art

In recent years, semiconductor production processes have become capable of producing semiconductor devices with increasingly fine feature sizes, as photolithography has been making rapid progress toward finer fabrication. In the next generation of semiconductor production processes, microfabrication with feature sizes at 60 nm to 45 nm, and further, microfabrication with feature sizes of 32 nm or less will be required. In order to meet the demand for microfabrication with feature sizes of 32 nm or less, for example, an exposure apparatus is needed which combines a system for generating EUV light at a wavelength of approximately 13 nm with a reduced projection reflective optical system.

Three kinds of systems for generating EUV light are known in general, which include a Laser Produced Plasma (LPP) type system in which plasma is generated by irradiating a target material with a laser beam, a Discharge Produced Plasma (DPP) type system in which plasma is generated by electric discharge, and a Synchrotron Radiation (SR) type system in which orbital radiation is used to generate plasma.

### SUMMARY

A laser apparatus according to one aspect of the present disclosure may include a master oscillator configured to output a pulse laser beam, at least one amplifier provided in a path of the pulse laser beam from the master oscillator, and at least one first optical isolator provided in the path of the pulse laser beam, the first optical isolator including a GaAs crystal as an electro-optic crystal.

An extreme ultraviolet light generation system according to another aspect of the present disclosure may include the above-described laser apparatus, a chamber, a target supply device configured to supply a target material into the chamber, and a focusing optical system for focusing a pulse laser beam from the laser apparatus inside the chamber.

### BRIEF DESCRIPTION OF THE DRAWINGS

Hereinafter, selected embodiments of the present disclosure will be described with reference to the accompanying drawings.

FIG. 1 schematically illustrates an exemplary configuration of an LPP-type EUV light generation system.

FIG. 2 schematically illustrates an exemplary configuration of a laser apparatus according to an embodiment of the present disclosure.

FIG. 3 schematically illustrates an exemplary configuration of an optical isolator according to an embodiment of the present disclosure.

FIG. 4 schematically illustrates an exemplary configuration of an electro-optic (EO) Pockels cell according to an embodiment of the present disclosure.

FIG. 5A shows a pulse waveform of a voltage to be applied to an EO Pockels cell.

FIG. 5B shows a change over time in a beam intensity of a laser beam transmitted through an EO Pockels cell.

FIG. 6 schematically illustrates an exemplary configuration of an EO Pockels cell optical isolator according to an embodiment of the present disclosure.

FIG. 7 schematically illustrates an exemplary configuration of a slab EO Pockels cell according to an embodiment of the present disclosure.

FIG. 8 shows an example of a model for a simulation on a slab EO Pockels cell.

FIG. 9 schematically illustrates an exemplary configuration of a first variation on a slab EO Pockels cell.

FIG. 10 schematically illustrates an exemplary configuration of a second variation on a slab EO Pockels cell.

FIG. 11 schematically illustrates an exemplary configuration of a third variation on a slab EO Pockels cell.

FIG. 12 is a descriptive view of an amplifier and an optical isolator includes an EO Pockels cell.

FIG. 13A is a sectional view of an amplifier and an optical isolator that includes an EO Pockels cell, taken along a YZ plane.

FIG. 13A is another sectional view of an amplifier and an optical isolator that includes an EO Pockels cell, taken along an XZ plane.

### DETAILED DESCRIPTION

Hereinafter, selected embodiments of the present disclosure will be described in detail with reference to the accompanying drawings. The embodiments to be described below are merely illustrative in nature and do not limit the scope of the present disclosure. Further, the configuration(s) and operation(s) described in each embodiment are not all essential in implementing the present disclosure. Note that like elements are referenced by like reference numerals and characters, and duplicate descriptions thereof will be omitted herein.

### Contents

### 1. Overview of EUV Light Generation System

### 1.1 Configuration

### 1.2 Operation

### 2. Laser Apparatus Including Optical Isolator

### 2.1 Configuration

### 2.2 Operation

### 2.3 Effects

### 3. Optical Isolator Including EO Pockels Cell

### 3.1 Mechanism of Optical Isolator Including EO Pockels Cell

3.2 EO Pockels Cell Optical Isolator for CO₂ laser Apparatus

### 4. Slab EO Pockels Cell

4.1 configuration and Mechanism of Slab EO Pockels Cell

### 4.2 Physical Properties of Electro-optic Crystal

### 4.3 Performance of Slab EO Pockels Cell

### 4.4 Variations of Slab EO Pockels Cell

### 5. Slab EO Pockels Cell Optical Isolator and Slab Amplifier

### 1. Overview of EUV Light Generation System

### 1.1 Configuration

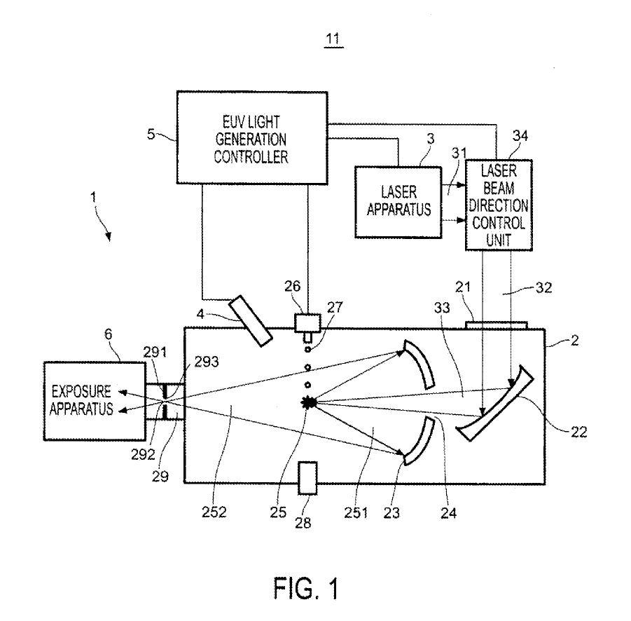

FIG. 1 schematically illustrates an exemplary configuration of an LPP type EUV light generation system. An EUV light generation apparatus 1 may be used with at least one laser apparatus 3. Hereinafter, a system that includes the EUV light generation apparatus 1 and the laser apparatus 3 may be referred to as an EUV light generation system 11. As shown in FIG. 1 and described in detail below, the EUV light generation system 11 may include a chamber 2 and a target supply device 26. The chamber 2 may be sealed airtight. The target supply device 26 may be mounted onto the chamber 2, for example, to penetrate a wall of the chamber 2. A target material to be supplied by the target supply device 26 may include, but is not limited to, tin, terbium, gadolinium, lithium, xenon, or any combination thereof.

The chamber 2 may have at least one through-hole or opening formed in its wall, and a pulse laser beam 32 may travel through the through-hole/opening into the chamber 2. Alternatively, the chamber 2 may have a window 21, through which the pulse laser beam 32 may travel into the chamber 2. An EUV collector mirror 23 having a spheroidal surface may, for example, be provided in the chamber 2. The EUV collector mirror 23 may have a multi-layered reflective film formed on the spheroidal surface thereof. The reflective film may include a molybdenum layer and a silicon layer, which are alternately laminated. The EUV collector mirror 23 may have a first focus and a second focus, and may be positioned such that the first focus lies in a plasma generation region 25 and the second focus lies in an intermediate focus (IF) region 292 defined by the specifications of an external apparatus, such as an exposure apparatus 6. The EUV collector mirror 23 may have a through-hole 24 formed at the center thereof so that a pulse laser beam 33 may travel through the through-hole 24 toward the plasma generation region 25.

The EUV light generation system 11 may further include an EUV light generation controller 5 and a target sensor 4. The target sensor 4 may have an imaging function and detect at least one of the presence, trajectory, position, and speed of a target 27.

Further, the EUV light generation system 11 may include a connection part 29 for allowing the interior of the chamber 2 to be in communication with the interior of the exposure apparatus 6. A wall 291 having an aperture 293 may be provided in the connection part 29. The wall 291 may be positioned such that the second focus of the EUV collector mirror 23 lies in the aperture 293 formed in the wall 291.

The EUV light generation system 11 may also include a laser beam direction control unit 34, a laser beam focusing mirror 22, and a target collector 28 for collecting targets 27. The laser beam direction control unit 34 may include an optical element (not separately shown) for defining the direction into which the pulse laser beam 32 travels and an actuator (not separately shown) for adjusting the position and the orientation or posture of the optical element.

### 1.2 Operation

With continued reference to FIG. 1, a pulse laser beam 31 outputted from the laser apparatus 3 may pass through the laser beam direction control unit 34 and be outputted therefrom as the pulse laser beam 32 after having its direction optionally adjusted. The pulse laser beam 32 may travel through the window 21 and enter the chamber 2. The pulse laser beam 32 may travel inside the chamber 2 along at least one beam path from the laser apparatus 3, be reflected by the laser beam focusing mirror 22, and strike at least one target 27 as a pulse laser beam 33.

The target supply device 26 may be configured to output the target(s) 27 toward the plasma generation region 25 in the chamber 2. The target 27 may be irradiated with at least one pulse of the pulse laser beam 33. Upon being irradiated with the pulse laser beam 33, the target 27 may be turned into plasma, and rays of light 251 including EUV light may be emitted from the plasma. At least the EUV light included in the light 251 may be reflected selectively by the EUV collector mirror 23. EUV light 252, which is the light reflected by the EUV collector mirror 23, may travel through the intermediate focus region 292 and be outputted to the exposure apparatus 6. Here, the target 27 may be irradiated with multiple pulses included in the pulse laser beam 33.

The EUV light generation controller 5 may be configured to integrally control the EUV light generation system 11. The EUV light generation controller 5 may be configured to process image data of the target 27 captured by the target sensor 4. Further, the EUV light generation controller 5 may be configured to control at least one of: the timing when the target 27 is outputted and the direction into which the target 27 is outputted. Furthermore, the EUV light generation controller 5 may be configured to control at least one of: the timing when the laser apparatus 3 oscillates, the direction in which the pulse laser beam 33 travels, and the position at which the pulse laser beam 33 is focused. It will be appreciated that the various controls mentioned above are merely examples, and other controls may be added as necessary.

In an LPP-type EUV light generation system, a high-power pulse laser beam may be required to obtain high-power EUV light. Thus, a laser apparatus in an LPP-type EUV light generation system may be required to output a pulse laser beam having high pulse energy at a high repetition rate. A high-power laser beam may, for example, be obtained by amplifying, in multiple stages, a pulse laser beam outputted from a master oscillator using a plurality of amplifiers. In such a master-oscillator power-amplifier (MOPA) system, an optical isolator that can withstand a high-power pulse laser beam may be provided in order to suppress backpropagating rays from a target and/or self-oscillation in an amplifier.

### 2. Laser Apparatus Including Optical Isolator

### 2.1 Configuration

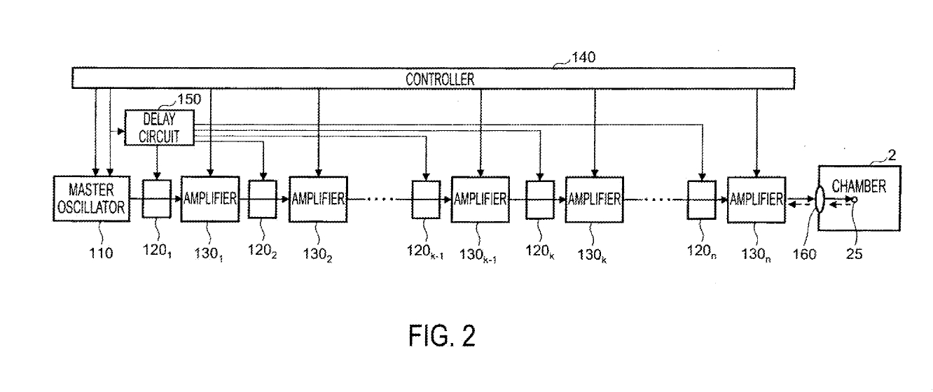

A laser apparatus pertaining to one or more embodiments of the present disclosure will now be described in detail with reference to the drawings. FIG. 2 schematically illustrates an exemplary configuration of a laser apparatus according to an embodiment of the present disclosure. The laser apparatus 3 may include a master oscillator 110, at least one optical isolator 120, at least one amplifier 130, a controller 140, and a delay circuit 150. The at least one optical isolator 120 may include a plurality of optical isolators 120₁ through 120ₙ. The at least one amplifier 130 may include a plurality of amplifiers 130₁ through 130ₙ. In FIG. 2, an optical isolator 120ₖ₋₁ and an optical isolator 120ₖ may be any optical isolators provided between the optical isolator 120₁ and the optical isolator 120ₙ. Similarly, an amplifier 130ₖ₋₁ and an amplifier 130ₖ may be any amplifiers provided between the amplifier 130₁ and the amplifier 130ₙ.

In the description to follow, the reference numeral “130” may be used to collectively designate the amplifiers 130₁ through 130ₙ. Similarly, the reference numeral “120” may be used to collectively designate the optical isolators 120₁ through 120ₙ. In FIG. 2, a laser beam focusing optical system 160 is shown, and the laser beam focusing optical system 160 may have a similar function to the laser beam focusing mirror 22 shown in FIG. 1. Further, in FIG. 2, the laser beam direction control unit 34 and so forth shown in FIG. 1 are omitted for the sake of simplifying the drawing.

The amplifiers 130 may be provided in a path of a pulse laser beam from the master oscillator 110. The optical isolators 120 may also be provided in the path of the pulse laser beam between the master oscillator 110 and the amplifier 130₁ or between any of the two adjacent amplifiers 130. For example, the optical isolator 120ₖ may be provided between the amplifier 130ₖ₋₁ and the amplifier 130ₖ.

The amplifier 130 may be include gas containing CO₂ gas as a gain medium. The amplifier 130 may include electrodes and a high-frequency power supply to pump the gain medium through a high-frequency electric discharge. The optical isolator 120 may include an EO Pockels cell and a polarizer unit and may function as an optical shutter. Details of the optical isolator 120 will be given later.

The master oscillator 110 may be configured to output a pulse laser beam in a bandwidth contained within a gain bandwidth of CO₂ gas (i.e., 9 μm to 10.6 μm) in accordance with a trigger signal from the laser controller 140. The laser controller 140 may be connected to each of the master oscillator 110, the optical isolators 120₁ through 120ₙ, the amplifiers 130₁ through 130ₙ, and the delay circuit 150 through respective signal lines. Signals transmitted through the aforementioned signal lines may include a signal for setting pumping intensities of the master oscillator 110 and the amplifiers 130₁ through 130ₙ.

Further, the delay circuit 150 may be configured to add a delay to a signal split from a trigger signal sent from the laser controller 140 to the master oscillator 110. Then, the delay circuit 150 may send that signal to the optical isolators 120 so that each of the optical isolators 120 opens in synchronization with a timing at which a pulse laser beam from the master oscillator 110 reaches the corresponding optical isolator 120. In one embodiment, the delay circuit 150 may be provided inside the laser controller 140.

### 2.2 Operation

The laser controller 140 may send signals to the master oscillator 110 and the amplifiers 130 to cause the master oscillator 110 and the amplifiers 130 to operate at predetermined pumping intensities, respectively. The laser controller 140 may also send trigger signals to the master oscillator 110 and the delay circuit 150.

Upon receiving a trigger signal, the master oscillator 110 may oscillate to output a pulse laser beam. The delay circuit 150 may send a signal to the optical isolator 120₁ at a timing delayed with respect to a received trigger signal. Thus, the optical isolator 120₁ may open at a timing at which the pulse laser beam from the master oscillator 110 reaches the optical isolator 120₁ and may close after the pulse laser beam has passed through the optical isolator 120₁.

The pulse laser beam that has passed through the optical isolator 120₁ may then enter the amplifier 130₁ to be amplified as the pulse laser beam passes through a pumped gain medium inside the amplifier 130₁. Then, as in the optical isolator 120₁, in accordance with a signal from the delay circuit 150, the optical isolator 120₂ may open at a timing at which the amplified pulse laser beam from the amplifier 130₁ reaches the optical isolator 120₂ and close after the pulse laser beam has passed through the optical isolator 120₂. Then, the pulse laser beam may enter the amplifier 130₂ to be further amplified in the amplifier 130₂. Similarly, the pulse laser beam from the amplifier 130ₖ₋₁ may pass through the optical isolator 120ₖ, and enter the amplifier 130ₖ to be further amplified in the amplifier 130ₖ. In this way, a high-power pulse laser beam may be obtained.

### 2.3 Effects

As described above, the optical isolator 120 may be controlled to allow the pulse laser beam to pass through only when the pulse laser beam from the master oscillator 110 passes therethrough and block the pulse laser beam at other times. Such configuration may make it possible to prevent amplified spontaneous emission (ASE) light generated in one of the amplifiers 130 from being amplified in any other amplifiers 130.

In addition, when a target 27 is irradiated with the pulse laser beam in the plasma generation region 25, a part of the pulse laser beam may be reflected by the target 27 and may enter the laser apparatus 3 as backpropagating rays. Such backpropagating rays may reach the laser apparatus 3 after the pulse laser beam from the master oscillator 110 has passed through all the optical isolators 120 provided therein. At that timing, all the optical isolators 120 may be closed. Thus, the backpropagating rays may be blocked by the optical isolators 120 and prevented from being amplified in the amplifiers 130.

### 3. Optical Isolator Including EO Pockels Cell

### 3.1 Mechanism of Optical Isolator Including EO Pockels Cell

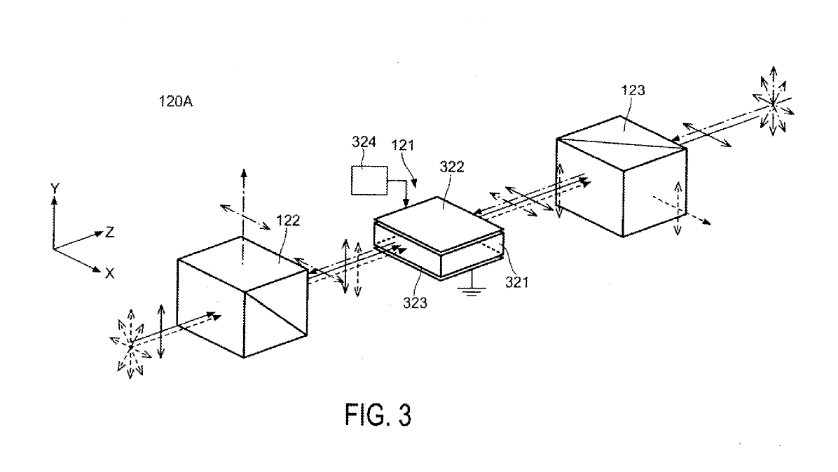

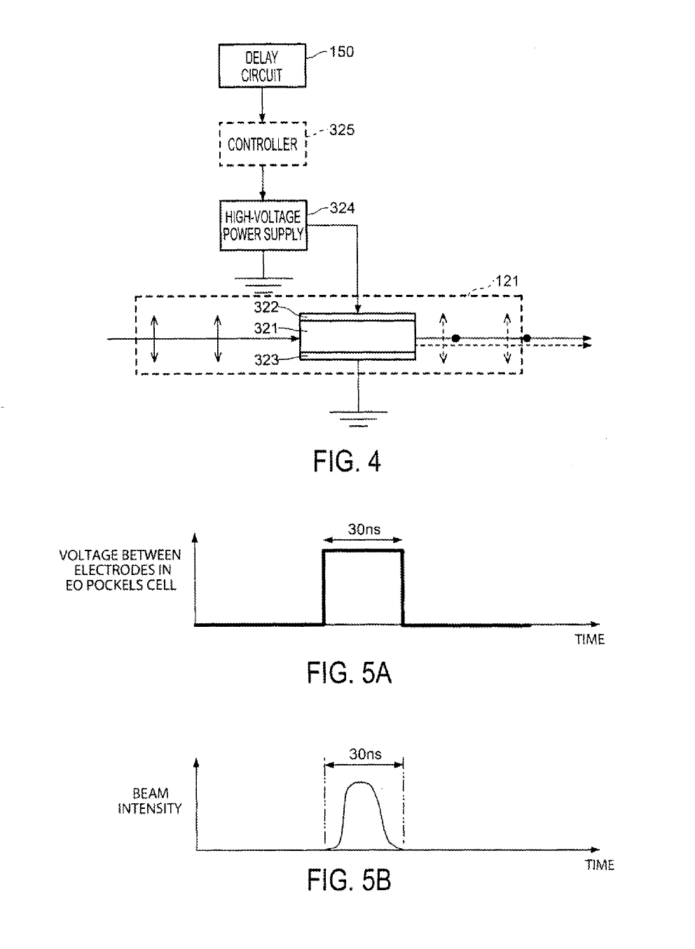

With reference to FIGS. 3 and 4, a mechanism of an optical isolator 120A that includes an EO Pockels Cell will be described as an example of the optical isolator 120.

The optical isolator 120A may include a first polarizer unit 122, a second polarizer unit 123, and an EO Pockels cell 121 provided between the first polarizer unit 122 and the second polarizer unit 123. The optical isolator 120A may further include a high-voltage power supply 324 that is connected to the EO Pockels cell 121. The optical isolator 120A may be positioned, when arranged in the laser apparatus 3, such that the first polarizer unit 122 is located upstream from the second polarizer unit 123 along a path of the pulse laser beam from the master oscillator 110.

The EO Pockels cell 121 may include an electro-optic crystal 321, a first electrode 322, and a second electrode 323. The electro-optic crystal 321 may be substantially rectangular parallelpiped in shape, and the first and second electrodes 322 and 323 may be provided on two opposite faces of the electro-optic crystal 321. The first electrode 322 may be connected to the high-voltage power supply 324, and the second electrode 323 may be grounded. As shown in FIG. 4, the high-voltage power supply 324 may be connected to the delay circuit 150 through a controller 325. The controller 325 may be configured to control the high-voltage power supply 324. In one embodiment, if the high-voltage power supply 324 has a function of controlling application of a voltage through a signal, the high-voltage power supply 324 may be directly connected to the delay circuit 150, as in the configuration shown in FIG. 2.

In FIG. 3, solid arrows indicate a pulse laser beam that enters the EO Pockels cell 121 through the first polarizer unit 122 when a high voltage is applied to the EO Pockels cell 121. Dotted arrows indicate ASE light, if any, that enters the EO Pockels cell 121 from the amplifier 130 through the first polarizer unit 122 when a high voltage is not applied to the EO Pockels cell 121. Dash-dotted arrows indicate ASE light, if any, from the amplifier 130 and/or backpropagating rays, if any, from a target 27 that enter the EO Pockels cell 121 through the second polarizer unit 123 when a high voltage is not applied to the EO Pockels cell 121.

The EO Pockels cell 121 may be configured to change the polarization of light that passes through the electro-optic crystal 321 while a predetermined voltage is applied between the first electrode 322 and the second electrode 323. That is, the polarization of light that passes through the electro-optic crystal 321 may not change when a voltage is not applied between the first electrode 322 and the second electrode 323.

For example, with reference to FIG. 3, when a pulse laser beam polarized in the Y-direction enters the EO Pockels cell to which a predetermined voltage is applied, a pulse laser beam polarized in the X-direction may be outputted from the EO Pockels cell 121. On the other hand, when a pulse laser beam polarized in the Y-direction enters the EO Pockels cell 121 to which a voltage is not applied, the pulse laser beam may be outputted from the EO Pockels cell 121 while remaining being polarized in the Y-direction. The aforementioned predetermined voltage may vary depending on the electro-optic crystal 321, and the details will be given later.

Each of the first polarizer unit 122 and the second polarizer unit 123 may be configured to split an incident pulse laser beam into two polarization components that are perpendicular to each other. For example, as shown in FIG. 3, each of the first polarizer unit 122 and the second polarizer unit 123 may be a polarization beam splitter configured of polarization prisms. The first polarizer unit 122 may be positioned and configured to allow the polarization component in the Y-direction to pass through and reflect the polarization component in the X-direction. The second polarizer unit 123 may be positioned and configured to allow the polarization component in the X-direction to pass through and reflect the polarization component in the Y-direction.

In operation, a pulse laser beam that enters the optical isolator 120A configured as described above may first enter the first polarization unit 122. Then, the polarization component in the Y-direction may pass through the first polarizer unit 122 and the polarization component in the X-direction may be reflected thereby. A beam dump (not separately shown) may be provided in a path of the pulse laser beam reflected by the first polarizer unit 122.

The pulse laser beam polarized in the Y-direction may then enter the EO Pockels cell 121 from the first polarizer unit 122. When a voltage is not applied to the EO Pockels cell 121, the pulse laser beam may be outputted from the EO Pockels cell 121 while remaining polarized in the Y-direction. Thereafter, the pulse laser beam polarized in the Y-direction may enter the second polarizer unit 123, and may be reflected by the second polarizer unit 123. Thus, the pulse laser beam that has entered the optical isolator 120A may be blocked by the optical isolator 120A.

On the other hand, when a predetermined voltage is applied to the EO Pockels cell 121, the pulse laser beam polarized in the Y-direction outputted from the first polarizer unit 122 may be converted in a pulse laser beam polarized in the X-direction by passing through the EO Pockels cell 121. Then, the pulse laser beam polarized in the X-direction may pass through the second polarizer unit 123, and enter an amplifier 130 provided downstream therefrom.

A part of the pulse laser beam to enter an amplifier 130 may be reflected by a component of the amplifier 130 and may travel back to the optical isolator 120A as backpropagating rays. Further, a part of the pulse laser beam to strike a target 27 in the plasma generation region 25 may be reflected by target 27 and may travel back to the optical isolator 120A as backpropagating rays. Such backpropagating rays that have entered the optical isolator 120A may first enter the second polarizer unit 123. Then, the polarization component in the X-direction may pass through the second polarizer unit 123, and the polarization component in the Y-direction may be reflected by the second polarizer unit 123. A beam dump (not separately shown) may be provided in a path of the polarization component reflected by the second polarizer unit 123.

When a voltage is not applied to the EO Pockels cell 121, the backpropagating rays polarized in the X-direction that have entered the EO Pockels cell 121 may be outputted from the EO Pockels cell 121 while remaining being polarized in the X-direction, and reflected by the first polarizer unit 122. Thus, the backpropagating rays may be blocked by the optical isolator 120A and prevented from traveling toward the master oscillator 110. For example, by providing the optical isolator 120A configured as such between the amplifiers 130, the backpropagating rays generated downstream from the optical isolator 120A may be prevented from entering the amplifier 130 upstream from the optical isolator 120A.

On the other hand, when a predetermined voltage is applied to the EO Pockels cell 121, the backpropagating rays polarized in the X-direction outputted from the second polarizer unit 123 may be converted into backpropagating rays polarized in the Y-direction by passing through the EO Pockels cell 121. Then the backpropagating rays polarized in the Y-direction may pass through the first polarizer unit 122, and travel back toward the master oscillator 110. Thus, it is preferable that a predetermined voltage is not applied to the EO Pockels cell 121 when backpropagating rays enter the EO Pockels cell 121.

That is, when the pulse laser beam from the master oscillator 110 enters the EO Pockels cell 121 through the first polarizer unit 122, a predetermined voltage may be applied to the EO Pockels cell 121. Meanwhile, when the backpropagating rays enter the EO Pockels cell 121 through the second polarizer unit 123, a voltage may not be applied to the EO Pockels cell 121. FIG. 5A shows an example of a voltage to be applied between the first electrode 322 and the second electrode 323 of the EO Pockels cell 121. For example, as shown in FIG. 5A, the high-voltage power supply 324 may apply a pulse voltage between the first electrode 322 and the second electrode 323. The optical isolator 120A functioning as an optical shutter may be open while a pulse voltage having a pulse duration of approximately 30 ns is applied between the first electrode 322 and the second electrode 323 as shown in FIGS. 5A and 5B. FIG. 5B shows a change over time in the intensity of the pulse laser beam passing through the EO Pockels cell 121 in the same time base as that of FIG. 5A. In this way, a pulse voltage may be applied to open the optical isolator 120A only while the pulse laser beam is passing through the EO Pockels cell 121. By applying a pulse voltage as such, the pulse laser beam may pass through the optical isolator 120A while the backpropagating rays may be blocked by the optical isolator 120A. Such configuration and operation may also prevent ASE light from passing through the optical isolator 120A.

### 3.2 EO Pockels Cell Optical Isolator for CO₂ Laser Apparatus

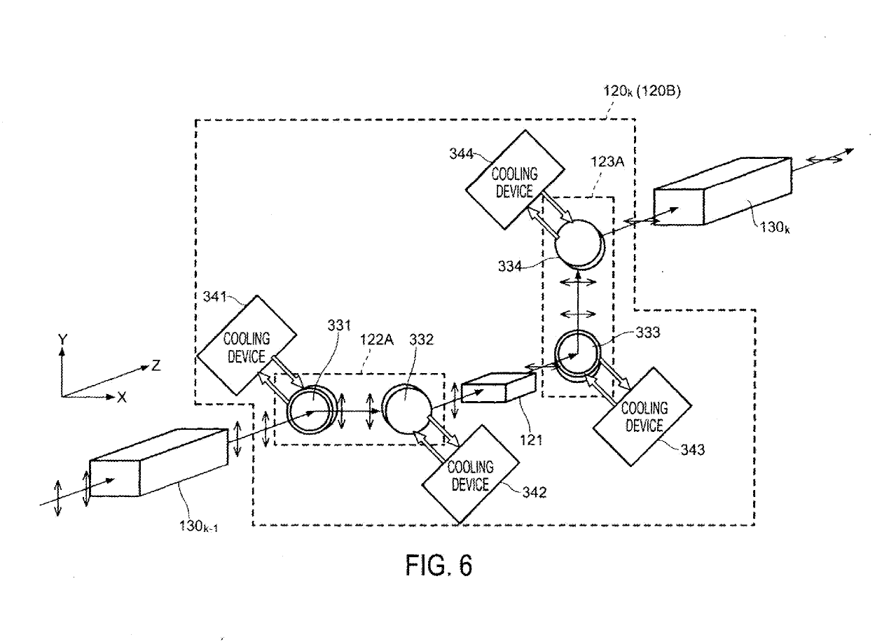

With reference to FIG. 6, a configuration of an EO Pockels cell optical isolator 120B to serve as the optical isolator 120 will be described. Transmissive polarization beam splitters are used in the first polarizer unit 122 and the second polarizer unit 123 in the optical isolator 120A shown in FIG. 3, but the transmissive beam splitters may break when a high-power pulse laser beam is incident thereon. Thus, as shown in FIG. 6, each of a first polarizer unit 122A and a second polarizer unit 123A may include a mirror that is configured to reflect an S-polarization component and absorb a P-polarization component. Such a mirror may be configured of a substrate that absorbs a laser beam at a given wavelength and that is coated with an optical thin film configured to reflect the S-polarization component and transmit the P-polarization component. FIG. 6 shows the EO Pockels cell optical isolator 120B serving as the optical isolator 120k provided between the amplifier 130k−1 and the amplifier 130k. However, the optical isolator 120B may be used as any of the optical isolators 120₁ through 120ₙ.

The optical isolator 120k shown in FIG. 6 may include the EO Pockels cell 121 and the high-voltage power supply 324 that are similar to those shown in FIG. 3, a first polarizer unit 122A and a second polarizer unit 123A. The first electrode (not separately shown) of the EO Pockels cell 121 may be connected to the high-voltage power supply 324, and the second electrode (not separately shown) thereof may be grounded. The first polarizer unit 122A may include a first mirror 331 and a second mirror 332 that are configured to reflect the S-polarization component and absorb the P-polarization component. Each of the first mirror 331 and the second mirror 332 may be positioned such that a polarization component in the Y-direction is incident thereon as the S-polarization component. Therefore, the polarization component in the Y-direction may be reflected by the first mirror 331 and the second mirror 332, and the polarization component in the X-direction may be absorbed by the first mirror 331 and the second mirror 332. Thus, only the polarization component in the Y-direction may be outputted from the first polarizer unit 122A. Here, since the polarization component in the X-direction may be absorbed by the first mirror 331 and the second mirror 332, heat may accumulate in the first mirror 331 and the second mirror 332. Therefore, a cooling device 341 may be connected to the first mirror 331, and a cooling device 342 may be connected to the second mirror 332. Thus, the first mirror 331 and the second mirror 332 may be prevented from overheating.

Similarly, the second polarizer unit 123A may include a third mirror 333 and a fourth mirror 334 that are configured to reflect the S-polarization component and absorb the P-polarization component. Each of the third mirror 333 and the fourth mirror 334 may be positioned such that the polarization component in the X-direction is incident thereon as the S-polarization component. Therefore, the polarization component in the X-direction may be reflected by the third mirror 333 and the fourth mirror 334, and the polarization component in the Y-direction may be absorbed by the third mirror 333 and the fourth mirror 334. Thus, only the polarization component in the X-direction may be outputted from the second polarizer unit 123A. Here, since the polarization component in the Y-direction may be absorbed by the third mirror 333 and the fourth mirror 334, heat may accumulate in the third mirror 333 and the fourth mirror 334. Accordingly, a cooling device 343 may be connected to the third mirror 333, and a cooling device 344 may be connected to the fourth mirror 334. Thus, the third mirror 333 and the fourth mirror 334 may be prevented from overheating.

In this way, the EO Pockels cell optical isolator 120B serving as the optical isolator 120k may be able to block backpropagating rays, as in the configuration shown in FIG. 3.

### 4. Slab EO Pockels Cell

4.1 configuration and Mechanism of Slab EO Pockels Cell

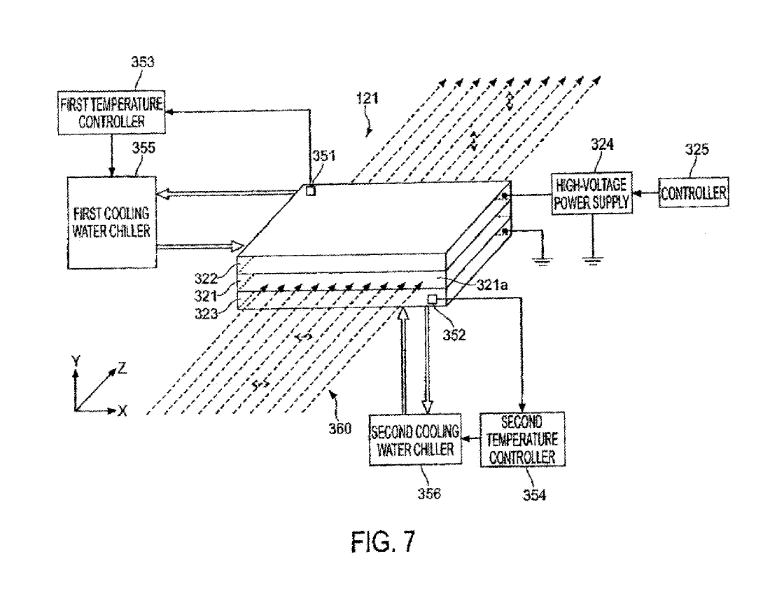

Subsequently, an exemplary configuration of the EO Pockels cell 121 will be described. As shown in FIG. 7, the EO Pockels cell 121 may include the electro-optic crystal 321 and the first and second electrodes 322 and 323 that are provided on two opposite faces of the substantially rectangular parallelpiped electro-optic crystal 321, as described above. The first electrode 322 may be connected to the high-voltage power supply 324, and the second electrode 323 may be grounded.

The electro-optic crystal 321 may be a plate-shaped, or slab, crystal that has a rectangular face 321a, and arranged such that a pulse laser beam is incident on the face 321a. The face 321a may be elongated in the x-direction. The electro-optic crystal 321 may, for example, be a GaAs crystal, a CdTe crystal, or the like. The first electrode 322 and the second electrode 323 may be formed of a metal material, may be provided on two opposite faces of the electro-optic crystal 321 that intersect with the face 321a. The first electrode 322 and the second electrode 323 may also function as heat sinks in which flow channels are formed, respectively, to allow cooling water to flow therein.

The first electrode 322 may be connected to an output terminal of the high-voltage power supply 324, and the second electrode 323 may be connected to a ground terminal of the high-voltage power supply 324. The high-voltage power supply 324 may be connected to the controller 325 through a signal line. A first temperature sensor 351 may be provided on the first electrode 322, and a second temperature sensor 352 may be provided on the second electrode 323. An electrically insulating member (not separately shown) may be provided between the first electrode 322 and the first temperature sensor 351, and an electrically insulating member (not separately shown) may be provided between the second electrode 323 and the second temperature sensor 352. The first temperature sensor 351 may be connected to a first temperature controller 353 through a wire, and the second temperature sensor 352 may be connected to a second temperature controller 354 through another wire. A first cooling water chiller 355 may be connected to the first electrode 322 through a cooling water pipe, and a second cooling water chiller 356 may be connected to the second electrode 323 through another cooling water pipe. The first temperature controller 353 may be connected to the first cooling water chiller 355 through a wire, and the second temperature controller 354 may be connected to the second cooling water chiller 356 through another wire.

The face 321a and a face opposite thereto of the electro-optic crystal 321 may be coated with anti-reflection films, respectively, to prevent a pulse laser beam at a given wavelength from being reflected thereby.

An exemplary operation of the EO Pockels cell 121 shown in FIG. 7 will now be described. In an example to be described below, a linearly polarized sheet-like pulse laser beam 360 having a polarization component in the X-direction as a primary component is incident on the face 321a of the electro-optic crystal 321.

A predetermined voltage may be applied between the first electrode 322 and the second electrode 323 in synchronization with a timing at which the pulse laser beam 360 enters the electro-optic crystal 321. Then, the pulse laser beam 360 may be outputted from the electro-optic crystal 321 as a pulse laser beam 360 polarized in the Y-direction. The high-voltage power supply 324 may apply a predetermined voltage between the first electrode 322 and the second electrode 323 in accordance with a signal from the controller 325. After the pulse laser beam 360 passes through the electro-optic crystal 321, the voltage between the first electrode 322 and the second electrode 323 may be brought to 0 by the high-voltage power supply 324 in accordance with a signal from the controller 325.

Further, the first temperature controller 353 may control the first cooling water chiller 355 and the second temperature controller 354 may control the second cooling water chiller 355 such that a temperature detected by the first temperature sensor 351 and a temperature detected by the second temperature sensor 352 stay at substantially the same predetermined temperature. In this way, by allowing heat generated in the electro-optic crystal 321 to dissipate through the first and second cooling water chillers 355 and 356, temperatures of the first electrode 322 and the second electrode 323 may be controlled to stay at substantially the same temperature. Accordingly, a temperature difference at various portions of the electro-optic crystal 321 may be reduced, and thus a distortion in a wavefront of the pulse laser beam 360 to be outputted from the electro-optic crystal 321 may be suppressed.

### 4.2 Physical Properties of Electro-Optic Crystal

Subsequently, the electro-optic crystal 321 in the EO Pockels cell 121 will be described. A GaAs crystal and a CdTe crystal may, for example, be used as an electro-optic crystal for a CO₂ laser beam. Various physical properties of a GaAs crystal and a CdTe crystal are shown in Table 1. As for a GaAs crystal, a relatively large crystal can be produced.

TABLE 1

| | GaAs | CdTe |
|---|---|---|
| Wavelength (μm) | 10.6 | 10.6 |
| Refractive Index | 3.275 | 2.674 |
| Absorption Coefficient (1/m) | 1 | 0.2 |
| Thermal Conductivity (W/(mK)) | 48 | 6.2 |
| dn/dT | 149 | 107 |
| Voltage to Shift by λ/2 (kVm/m) | 100 | 53 |
| Modulus of Rupture (Mpa) | 137.9 | 22 |

With reference to Table 1, the thermal conductivity of a GaAs crystal is 48 W/(mK), and is approximately 8 times greater than the thermal conductivity of a CdTe crystal, which is 6.2 W/(mK). Thus, a temperature difference in various portions of the electro-optic crystal 321 can be reduced when a GaAs crystal is used as the electro-optic crystal 321 than when a CdTe crystal is used, and a distortion in the wavefront of the pulse laser beam when being transmitted through the electro-optic crystal 321 can be reduced. Further, the modulus of rupture of a GaAs crystal is 137.9 Mpa, and is approximately 6 times greater than the modulus of rupture of a CdTe crystal, which is 22 Mpa. Thus, a rupture of the electro-optic crystal 321 can be better suppressed when a GaAs crystal is used as the electro-optic crystal 321 than when a CdTe crystal is used, even in a case where power of the incident laser pulse beam is high.

On the other hand, the absorption coefficient of a CdTe crystal is 0.2 (1/m), and is approximately ⅕ of the absorption coefficient of a GaAs crystal, which is 1 (1/m). Thus, an optical loss of the pulse laser beam passing through the electro-optic crystal 321 can be better reduced when a CdTe crystal is used as the electro-optic crystal 321 than when a GaAs crystal is used. Further, a voltage required to shift a phase of the pulse laser beam by a half-wave through a CdTe crystal is 53 kVm/m, and is approximately ½ of a voltage required to shift a phase of the pulse laser beam by a half-wave through a GaAs crystal, which is 100 kVm/m. Thus, the polarization of the laser beam passing through the electro-optic crystal 321 can be changed with a lower voltage when a CdTe crystal is used as the electro-optic crystal 321 than when a GaAs crystal is used, which may lead to lower power consumption.

Based on the above, as the electro-optic crystal 321, a GaAs crystal, which has a higher modulus of rupture and higher thermal conductivity, is preferable when the power of the incident pulse laser beam is high, and a CdTe crystal, which has a lower absorption coefficient and requires a lower voltage shift a phase of the pulse laser beam by a half-wave, is preferable in other cases.

In the laser apparatus 3, part of the plurality of optical isolators 120₁ through 120ₙ may include a GaAs crystal and another part of the plurality of optical isolators 120₁ through 120ₙ may include a CdTe crystal. For example, the optical isolators 120₁ through 120ₘ₋₁ may include the electro-optic crystal 321 formed of a CdTe crystal, and the optical isolators 120ₘ through 120ₙ may include the electro-optic crystal 321 formed of a GaAs crystal. Here, m is any natural number that satisfies the condition 1<m<n.

In one embodiment, of the optical isolators 120₁ through 120ₙ, the optical isolator 120₁ on which the pulse laser beam outputted from the master oscillator 110 is first incident may include the electro-optic crystal 321 formed of a CdTe crystal. In one embodiment, the optical isolator 120ₙ from which the pulse laser beam to be outputted from the laser apparatus 3 is outputted may include the electro-optic crystal 321 formed of a GaAs crystal. That is, the uppermost-stream optical isolator 120₁ may include the electro-optic crystal 321 formed of a CdTe crystal, and the downmost-stream optical isolator 120ₙ may include the electro-optic crystal 321 formed of a GaAs crystal. Note that in the present specification, an optical isolator in which a GaAs crystal is used as an electro-optic crystal may be referred to as a first optical isolator, and an optical isolator in which a CdTe crystal is used as an electro-optic crystal may be referred to as a second optical isolator.

### 4.3 Performance of Slab EO Pockels Cell

Subsequently, the performance of the slab EO Pockels cell 121 will be described. A thermal simulation has been carried out and a distortion in the wavefront of the pulse laser beam has been calculated for each of the cases where a GaAs crystal and a CdTe crystal are used as the electro-optic crystal. The crystal size of the electro-optic crystal, input energy of the pulse laser beam, and a beam width (1/e₂) of the pulse laser beam in this thermal simulation are shown in Table 2.

TABLE 2
Simulation Conditions

| | |
|---|---|
| Crystal Size | 100 mm × 2 mm × 50 mm |
| Input Energy of Pulse Laser Beam | 2 kW |
| Beam Dimensions (1/e²) of Laser Beam | X: 60 mm, Y: 1 mm |

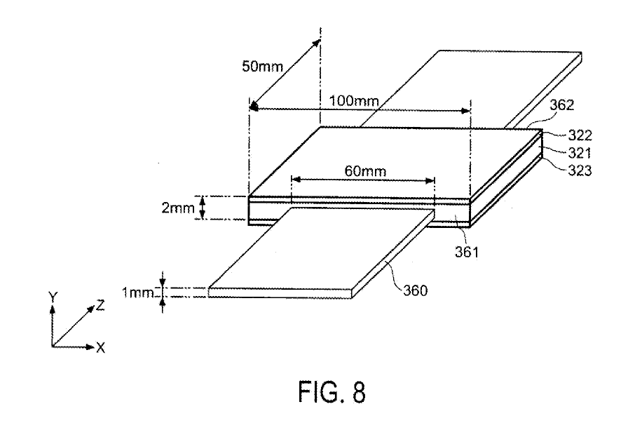

The model used in this thermal simulation is the electro-optic crystal 321 where the crystal size is 100 mm×2 mm×50 mm, as shown in FIG. 8. The input energy of the incident sheet-like laser beam 360 is 2 kW, and the beam dimensions (1/e²) of the sheet-like laser beam 360 is 60 mm in the X-direction and 1 mm in the Y-direction. Here, faces of the GaAs crystal and the CdTe crystal on which the laser beam 360 is incident are coated with anti-reflection films 361, respectively, and faces of the GaAs crystal and the CdTe crystal from which the laser beam 360 is outputted are coated with anti-reflection films 362, respectively.

The result of the thermal simulation are shown in Table 3.

TABLE 3

| | GaAs | CdTe |
|---|---|---|
| Transmittance (%) | 94.8 | 98.7 |
| Voltage to Shift by λ/2 (kV) | 4 | 2.1 |
| M² of Output Laser Beam | X: 1.40 | X: 1.52 |
| | Y: 1.03 | Y: 1.04 |
| Focal Distance by Thermal Lens Effect (m) | X: 207 | X: 173 |
| | Y: 153 | Y: 129 |
| Maximum Temperature Increase (° C.) | 0.46 | 0.76 |

As shown in Table 3, the transmittance is 94.8% for the GaAs crystal and 98.7% for the CdTe crystal, and thus the transmittance is higher in the CdTe crystal than in the GaAs crystal. However, the transmittance of the GaAs crystal is sufficiently high to use the GaAs crystal in the EO Pockels cell 121.

The voltage required to shift a phase of the laser beam 360 by a half-wave is 4 kV for the GaAs crystal and 2.1 kV for the CdTe crystal, and thus the aforementioned voltage is approximately twice higher for the GaAs crystal than for the CdTe crystal. However, as for the GaAs crystal, if the voltage to be applied is at this level, the GaAs crystal can be used in the EO Pockels cell 121.

The value of M² of the output laser beam is 1.40 in the X-direction and 1.03 in the Y-direction for the GaAs crystal, whereas it is 1.52 in the X-direction and 1.04 in the Y-direction for the CdTe crystal. Thus, the value of M² of the output laser beam through the GaAs crystal is substantially the same or smaller than the value of M² of the output laser beam through the CdTe crystal. Accordingly, deterioration in the beam quality of the transmitted laser beam is smaller in the GaAs crystal than in the CdTe crystal. However, the value of M² of the output laser beam through the CdTe crystal is also at such a level that the CdTe crystal can be used as well. Note that this result is based on a simulation under the condition where M² of the incident laser beam is 1.

The focal distance through a thermal lens effect is 207 m in the X-direction and 153 m in the Y-direction for the GaAs crystal, whereas it is 173 m in the X-direction and 129 m in the Y-direction for the CdTe crystal, and thus the focal distance through the thermal lens effect is longer for the GaAs crystal than for the CdTe crystal. Thus, influences of the thermal lens effect can be smaller in the GaAs crystal than in the CdTe crystal. However, the focal distance through a thermal lens effect in the CdTe crystal is also at such a level that the CdTe crystal can be used as well.

The maximum temperature increase is 0.46° C. in the GaAs crystal and 0.76° C. in the CdTe crystal. Thus, since the maximum temperature increase is smaller in the GaAs crystal than in the CdTe crystal, the effect of heat is smaller in the GaAs crystal. However, the maximum temperature increase in the CdTe crystal is also at such a level that the CdTe crystal can be used as well.

### 4.4 Variations of Slab EO Pockels Cell

### First Variation

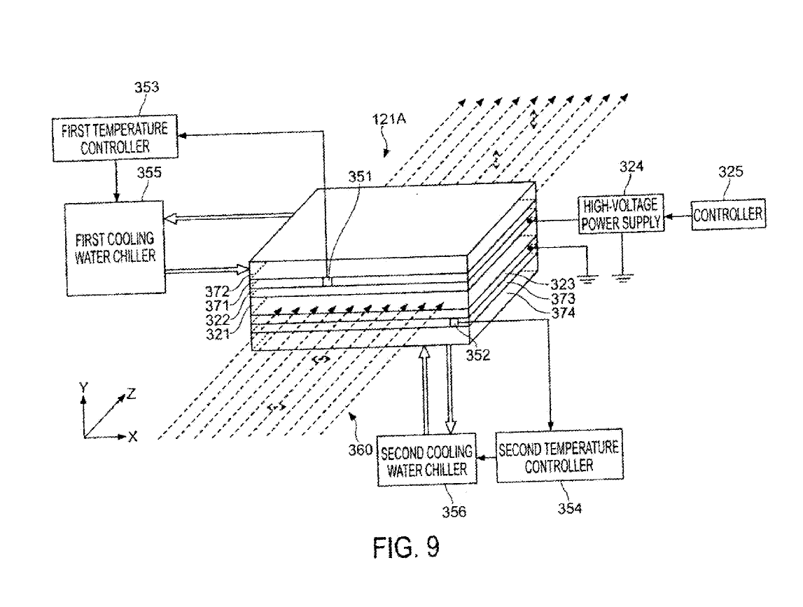

With reference to FIG. 9, an exemplary configuration of a first variation of a slab EO Pockels cell serving as the EO Pockels cell 121 will be described. An EO Pockels cell 121A shown in FIG. 9 may include the electro-optic crystal 321 and the first and second electrodes 322 and 323 that provided on opposite faces of the substantially rectangular parallelpiped electro-optic crystal 321, as in the EO Pockels cell 121 described above. The first electrode 322 may be connected to the high-voltage power supply 324. The second electrode 323 may be grounded. An electrically insulating member 371 and a heat sink 372 serving as a cooling unit may be provided on the first electrode 322. An electrically insulating member 373 and a heat sink 374 serving as a cooling unit may be provided on the second electrode 323.

The electro-optic crystal 321 may, for example, be a GaAs crystal, a CdTe crystal, or the like. The first electrode 322 and the second electrode 323 may be formed by depositing a metal material on the two opposite faces of the electro-optic crystal 321 or by adhering metal members on the two opposite faces of the electro-optic crystal 321.

The electrically insulating member 371 may be provided on a face of the first electrode 322 which is not in contact with the electro-optic crystal 321, and the electrically insulating member 373 may be provided on a face of the second electrode 323 which is not in contact with the electro-optic crystal 321. Each of the electrically insulating member 371 and the electrically insulating member 373 may be formed of a material having a higher thermal conductivity than the electro-optic crystal 321. For example, each of the electrically insulating members 371 and 373 may be a diamond substrate or may be a diamond film formed through vapor deposition. In one embodiment, each of the electrically insulating members 371 and 373 may, for example, be formed of a ceramic material that is highly electrically insulating and has a high thermal conductivity such as aluminum nitride (AlN) and aluminum oxide (Al₂O₃). That is, a substrate formed of diamond, which has the thermal conductivity of 2000 W/(mK), or AlN, which has the thermal conductivity of 200 W/(mK), having a higher thermal conductivity than the electro-optic crystal 321 such as GaAs and CdTe may be used as each of the electrically insulating members 371 and 373. In one embodiment, each of the electrically insulating members 371 and 373 may be a diamond film or the like applied on each of the first electrode 322 and the second electrode 323.

The heat sink 372 may be provided on the electrically insulating member 371, and the heat sink 374 may be provided on the electrically insulating member 373. Each of the heat sinks 372 and 374 may be formed of a material containing a metal material such as Al and Cu having a high thermal conductivity. Flow channels may be formed in the heat sinks 372 and 374, respectively, through which cooling water may circulate in the heat sinks 372 and 374.

The first electrode 322 may be connected to an output terminal of the high-voltage power supply 324, and the second electrode 323 may be connected to a ground terminal of the high-voltage power supply 324. The high-voltage power supply 324 may be connected to the controller 325 through a signal line. The first temperature sensor 351 may be provided on the electrically insulating member 371, and the second temperature sensor 352 may be provided on the electrically insulating member 373. The first temperature sensor 351 may be connected to the first temperature controller 353 through a wire, and the second temperature sensor 352 may be connected to the second temperature controller 354 through another wire. The first cooling water chiller 355 may be connected to the heat sink 372 through a cooling water pipe, and the second cooling water chiller 356 may be connected to the heat sink 374 through another cooling water pipe. The first temperature controller 353 may be connected to the first cooling water chiller 355 through a wire, and the second temperature controller 354 may be connected to the second cooling water chiller 356 through another wire.

In the EO Pockels cell 121A, faces of the electro-optic crystal 321 on which the laser beam in incident and from which the laser beam is outputted may be coated with anti-reflection films (not separately shown), respectively, to prevent the laser beam 360 from being reflected thereby.

Subsequently, an exemplary operation of the EO Pockels cell 121A will be described. In an example to be described below, a linearly polarized sheet-like pulse laser beam 360 having a polarization component in the X-direction as a primary component is incident on the electro-optic crystal 321 of the EO Pockels cell 121A.

A predetermined voltage may be applied between the first electrode 322 and the second electrode 323 in synchronization with a timing at which the pulse laser beam 360 enters the electro-optic crystal 321. Then, the pulse laser beam 360 may be outputted from the electro-optic crystal 321 as a pulse laser beam 360 polarized in the Y-direction. The high-voltage power supply 324 may apply a predetermined voltage between the first electrode 322 and the second electrode 323 in accordance with a signal from the controller 325. After the pulse laser beam 360 passes through the electro-optic crystal 321, the voltage between the first electrode 322 and the second electrode 323 may be brought to 0 by the high-voltage power supply 324 in accordance with a signal from the controller 325.

The first temperature controller 353 may control the first cooling water chiller 355 and the second temperature controller 354 may control the second cooling water chiller 356 such that a temperature detected by the first temperature sensor 351 and a temperature detected by the second temperature sensor 352 stay at substantially the same predetermined temperature. For example, the temperature of the heat sink 372 may be controlled through the first cooling water chiller 355 under the control of the first temperature controller 353. Similarly, the temperature of the heat sink 374 may be controlled through the second cooling water chiller 356 under the control of the second temperature controller 354.

In this way, in the EO Pockels cell 121A, by allowing heat generated in the electro-optic crystal 321 to dissipate, the temperature of the first electrode 322 and the temperature of the second electrode 323 may be controlled to stay at a predetermined temperature. Accordingly, a temperature difference among various portions of the electro-optic crystal 321 may be reduced, and a distortion in the wavefront of the pulse laser beam 360 to be outputted from the electro-optic crystal 321 may be suppressed.

In the EO Pockels cell 121A shown in FIG. 9, the electrically insulating members 371 and 373 may electrically insulate the heat sinks 372 and 374 and the first and second temperature sensors 351 and 352 from the first and second electrodes 322 and 323.

### Second Variation

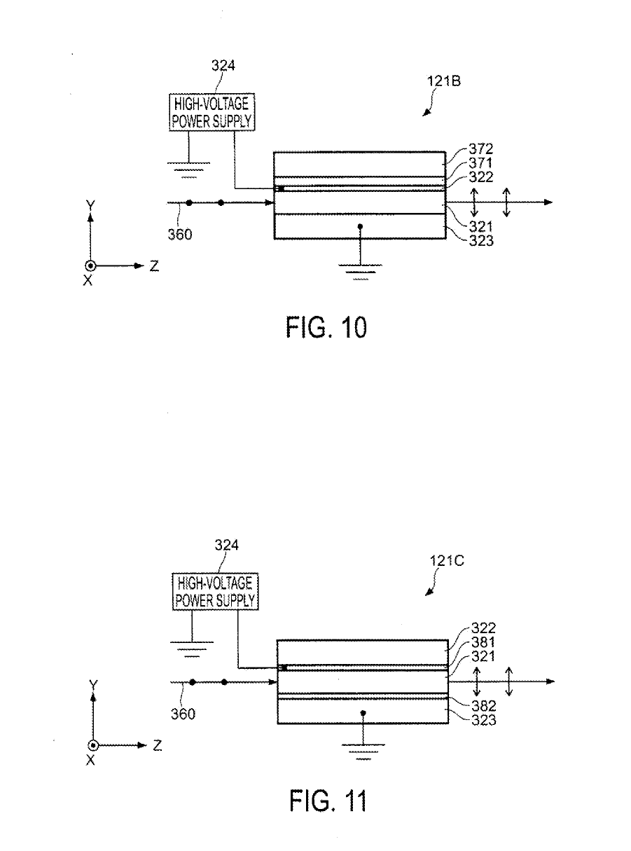

With reference to FIG. 10, an exemplary configuration of a second variation of a slab EO Pockels cell serving as the EO Pockels cell 121 will be described. An EO Pockels cell 121B shown in FIG. 10 may include the electro-optic crystal 321 and the first and second electrodes 322 and 323 provided on opposite faces of the substantially rectangular parallelpiped electro-optic crystal 321. The first electrode 322 may be connected to the high-voltage power supply 324. The second electrode 323 may be grounded. In the EO Pockels cell 121B, although the electrically insulating member 371 and the heat sink 372 may be provided on the first electrode 322, an electrically insulating member and a heat sink may not be provided on the second electrode 323.

### Third Variation

With reference to FIG. 11, an exemplary configuration of a third variation of a slab EO Pockels cell serving as the EO Pockels cell 121 will be described. In an EO Pockels cell 121C shown in FIG. 11, a diamond coat part 381 may be provided between the electro-optic crystal 321 and the first electrode 322, and a diamond coat part 382 may be provided between the electro-optic crystal 321 and the second electrode 323. For example, the diamond coat parts 381 and 382 may be formed of diamond coating formed on the two opposite faces of the plate-shaped electro-optic crystal 321 on which the first electrode 322 and the second electrode 323 are to be provided. The first electrode 322 may be in contact with the diamond coat part 381, and the second electrode 323 may be in contact with the diamond coat part 382.

Each of the first electrode 322 and the second electrode 323 may be formed of an electrode that includes a heat sink and is thus capable of temperature control.

In this way, by providing the diamond coat part 381 between the electro-optic crystal 321 and the first electrode 322 and the diamond coat part 382 between the electro-optic crystal 321 and the second electrode 323, a temperature difference generated in the electro-optic crystal 321 may be reduced.

### 5. Slab EO Pockels Cell Optical Isolator and Slab Amplifier

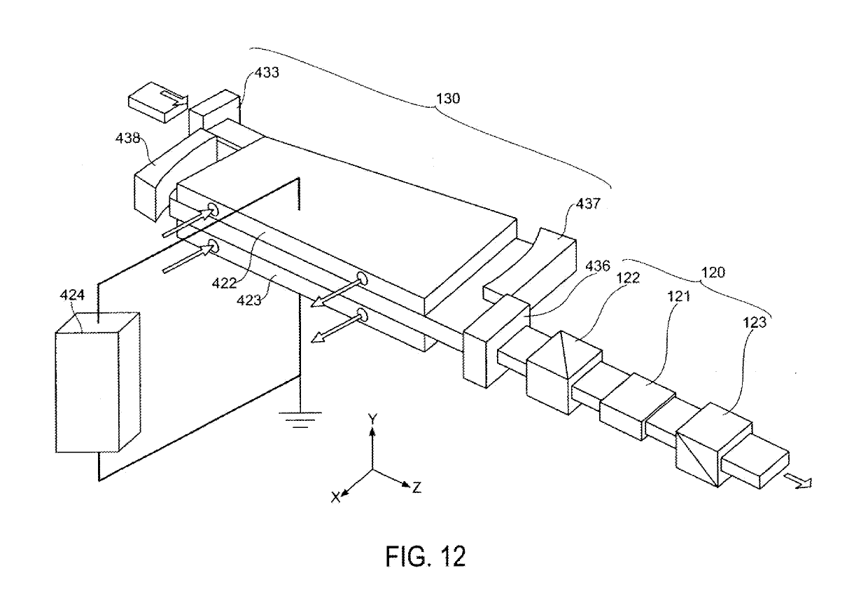

Subsequently, with reference to FIG. 12, an optical isolator 120 including a slab EO Pockels cell and a slab amplifier 130 will be described. FIG. 12 is a perspective view showing a state where an amplifier 130 and an optical isolator 120 are arranged in a laser apparatus 3.

The amplifier 130 may include a chamber (not separately shown), a pair of flat electrodes 422 and 423, a high-frequency (RF) power supply 424, an input window 433, an output window 436, and reversing mirrors 437 and 438.

The amplifier 130 may be configured such that the pair of flat electrodes 422 and 423 is arranged to sandwich therebetween the chamber (not separately shown) of the amplifier 130 filled with a laser medium. When a high-frequency voltage is applied between the flat electrodes 422 and 423 from the RF power supply 424, a high-frequency electric field may be generated between the flat electrodes 422 and 423, and a high-frequency discharge may occur in the laser medium. Thus, the laser medium may be excited. In this state, a pulse laser beam that has entered the chamber of the amplifier 130 through the input window 433 may be reflected by the reversing mirrors 437 and 438 to pass through the excited laser medium, to thereby be amplified. The pulse laser beam amplified in the chamber of the amplifier 130 in this way may be outputted from the chamber of the amplifier 130 through the output window 436 to enter the optical isolator 120.

Here, the reversing mirrors 437 and 438 may be configured as a conjugate optical system with which an image of the pulse laser beam at a predetermined position at the input side of the amplifier 130 is transferred at a predetermined position at the output side of the amplifier 130. The predetermined positions in this case may be any positions in a path of the pulse laser beam which may be determined by design. The input pulse laser beam and the output pulse laser beam may be sheet-like pulse laser beams.

The sheet-like pulse laser beam may have such dimensions that the beam width in the direction parallel to the electrodes 422 and 423 (i.e., the X-direction) is greater than the beam width in the direction perpendicular to the electrodes 422 and 423 (i.e., the Y-direction). That is, the lengthwise direction of the beam profile of the sheet-like pulse laser beam may be parallel to the electrodes 422 and 423.

An optical isolator 120 may be provided between the amplifiers 130. As described above, this optical isolator 120 may include the EO Pockels cell 121, the first polarizer unit 122, and the second polarizer unit 123. The optical isolator 120 may be arranged such that the sheet-like pulse laser beam enters the EO Pockels cell 121 in a state where the lengthwise direction of the beam profile of the sheet-like pulse laser beam substantially coincides with the lengthwise direction of the cross-section of the EO Pockels cell 121.

In this way, an optical isolator 120 may be provided in accordance with the beam shape of the sheet-like pulse laser beam inputted to and outputted from the slab amplifier 130. As a result, an optical system for converting the beam profile of a pulse laser beam to enter the slab amplifier 130 each time into a sheet-like shape can be omitted. Accordingly, the number of optical elements can be reduced, and the alignment of the optical elements can be facilitated.

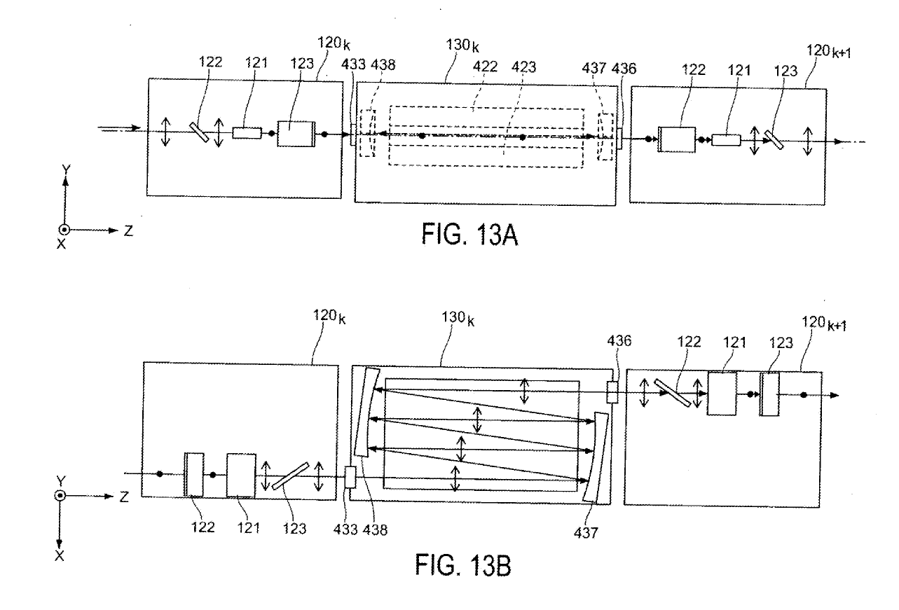

FIGS. 13A and 13B show a state where the optical isolators 120ₖ and 120ₖ₊₁ are provided respectively upstream and downstream from the amplifier 130ₖ. FIG. 13A is a sectional view taken along a YZ plane, and FIG. 13B is another sectional view taken along an XZ plane.

A linearly polarized laser beam polarized in the Y-direction may enter the optical isolator 120ₖ, and pass through the first polarizer unit 122 therein. A predetermined voltage may be applied between the electrodes of the EO Pockels cell 121 from a high-frequency power supply (not separately shown), and thus the polarization direction of the laser beam that enters the EO Pockels cell 121 may be converted into the X-direction, and the linearly polarized laser beam polarized in the X-direction may be outputted from the EO Pockels cell 121.

The linearly polarized laser beam polarized in the X-direction may then pass through the second polarizer unit 123, and enter the amplifier 130ₖ through the input window 433. The laser beam that has entered the amplifier 130ₖ may travel through a discharge region formed between the electrodes 422 and 423 in the amplifier 130ₖ multiple times by being reflected by the reversing mirrors 437 and 438, to thereby be amplified, and the amplified laser beam may be outputted through the output window 436.

The linearly polarized laser beam polarized in the X-direction outputted through the output window 436 may enter the optical isolator 120ₖ₊₁, and pass through the first polarizer unit 122. A predetermined voltage may be applied between the electrodes of the EO Pockels cell 121 from a high-frequency power supply (not separately shown), and thus the polarization direction of the laser beam that enters the EO Pockels cell 121 may be converted into the Y-direction, and the linearly polarized laser beam polarized in the Y-direction may be outputted from the EO Pockels cell 121.

The linearly polarized laser beam polarized in the Y-direction may pass through the second polarizer unit 123 in the optical isolator 120ₖ₊₁ and enter an amplifier 130 provided downstream therefrom.

Each optical element in the first polarizer unit 122 and the second polarizer unit 123 of the optical isolator 120ₖ and the optical isolator 120ₖ₊₁ may include a substrate that allows a CO₂ laser beam to pass therethrough, and the substrate may be coated with a film configured to transmit the P-polarization component and reflect the S-polarization component. A diamond substrate may be used as the substrate for the aforementioned optical element.

Here, the laser apparatus 3 described above can be used in the EUV light generation system shown in FIG. 1.

The above-described examples and the modifications thereof are merely examples for implementing the present disclosure, and the present disclosure is not limited thereto. Making various modifications according to the specifications or the like is within the scope of the present disclosure, and other various examples are possible within the scope of the present disclosure. For example, the modifications illustrated for particular ones of the examples can be applied to other examples as well (including the other examples described herein).

The terms used in this specification and the appended claims should be interpreted as “non-limiting.” For example, the terms “include” and “be included” should be interpreted as “including the stated elements but not limited to the stated elements.” The term “have” should be interpreted as “having the stated elements but not limited to the stated elements.” Further, the modifier “one (a/an)” should be interpreted as “at least one” or “one or more.”

What is claimed is:

1. A laser apparatus, comprising:
a master oscillator configured to output a pulse laser beam;
at least one amplifier provided in a path of the pulse laser beam from the master oscillator; and
at least one first optical isolator provided in the path of the pulse laser beam, the first optical isolator including a GaAs crystal as an electro-optic crystal.

2. The laser apparatus according to claim 1, further comprising:
at least one second optical isolator provided in the path of the pulse laser beam, the second optical isolator including a CdTe crystal as an electro-optic crystal.

3. The laser apparatus according to claim 2, wherein
the first optical isolator is provided upstream from the second optical isolator in the path of the pulse laser beam.

4. The laser apparatus according to claim 2, further comprising:
a controller connected to the master oscillator, the first optical isolator, and the second optical isolator,
wherein each of the first optical isolator and the second optical isolator includes:
a first polarization unit;
a second polarization unit;
an electro-optic Pockels cell provided between the first polarization unit and the second polarization unit, the electro-optic Pockels cell including the electro-optic crystal; and
a power supply configured to apply a voltage to the electro-optic Pockels cell, and
wherein the controller is configured to control the power supply.

5. The laser apparatus according to claim 2, wherein
one face of the electro-optic crystal on which the pulse laser beam in incident is elongated.

6. The laser apparatus according to claim 2, wherein:
the electro-optic Pockels cell includes a first electrode and a second electrode that are arranged to face each other with the electro-optic crystal provided therebetween; and
a cooling unit is provided in at least one of the first electrode and the second electrode.

7. The laser apparatus according to claim 6, wherein
the cooling unit is provided to at least one of the first and second electrodes with an electrically insulating member provided therebetween.

8. The laser apparatus according to claim 7, wherein
the electrically insulating member is formed of a material including at least one of diamond, aluminum nitride, and aluminum oxide.

9. The laser apparatus according to claim 2, wherein
the amplifier is a slab amplifier.

10. An extreme ultraviolet light generation system, comprising:
the laser apparatus of claim 1;
a chamber;
a target supply device configured to supply a target material into the chamber; and
a focusing optical system for focusing a pulse laser beam from the laser apparatus inside the chamber.
